(19) United States
(12) Patent Application Publication
(10) Pub. No.: US 2014/0198839 A1
(43) Pub. Date: Jul. 17, 2014

(54) LOW LATENCY SUB-FRAME LEVEL VIDEO DECODING

(71) Applicant: NVIDIA Corporation, Santa Clara, CA (US)

(72) Inventors: Mandar Anil Potdar, Pune (IN); Kishore Kumar Kunche, Gachibowli (IN)

(73) Assignee: NVIDIA Corporation, Santa Clara, CA (US)

(21) Appl. No.: 13/743,352

(22) Filed: Jan. 17, 2013

(51) Int. Cl. H04N 7/26

(52) U.S. Cl. CPC H04N 19/00939
USPC 375/240.02

(57) ABSTRACT

A method includes transmitting encoded video data related to video frames of a video stream from a source to a client device through a network such that a packet of the encoded video data is limited to including data associated with one portion of a video frame. The video frame includes a number of portions including the one portion. The method also includes time-stamping, through the client device and/or the source, the video frames such that packets of a video frame have a common timestamp. Further, the method includes decoding, at the client device, the video frames at a level of a portion of a video frame instead of a level of the video frame based on the time-stamping.

### FIELD OF TECHNOLOGY

This disclosure relates generally to real-time video decoding and, more particularly, to low latency sub-frame level video decoding.

### BACKGROUND

A cloud-computing application such as cloud-gaming may involve generating data in real-time on a remote server, encoding the aforementioned data as video and transmitting the aforementioned video to a client device through a network (e.g., Internet, Wide Area Network (WAN), Local Area Network (LAN)). The interactivity of the cloud-computing application may demand minimal latency. In the latency-critical cloud-gaming scenario, latency beyond a threshold may severely degrade the gaming experience of a user at a client device.

### SUMMARY

Disclosed are a method, a device and/or a system of low latency sub-frame level video decoding.

In one aspect, a method includes transmitting encoded video data related to video frames of a video stream from a source to a client device through a network such that a packet of the encoded video data is limited to including data associated with one portion of a video frame. The video frame includes a number of portions including the one portion. The method also includes time-stamping, through the client device and/or the source, the video frames such that packets of a video frame have a common timestamp. Further, the method includes decoding, at the client device, the video frames at a level of a portion of a video frame instead of a level of the video frame based on the time-stamping.

In another aspect, a non-transitory medium, readable through a data processing device and including instructions embodied therein that are executable through the data processing device, is disclosed. The non-transitory medium includes instructions to receive encoded video data related to video frames of a video stream transmitted from a source at the data processing device through a network such that a packet of the encoded video data is limited to including data associated with one portion of a video frame. The video frame includes a number of portions including the one portion. The non-transitory medium also includes instructions to time stamp, through the data processing device, the video frames such that packets of a video frame have a common timestamp. Further, the non-transitory medium includes instructions to decode, at the data processing device, the video frames at a level of a portion of a video frame instead of a level of the video frame based on the time-stamping.

In yet another aspect, a system includes a source to transmit encoded video data related to video frames of a video stream such that a packet of the encoded video data is limited to including data associated with one portion of a video frame. The video frame includes a number of portions including the one portion. The system also includes a network and a client device communicatively coupled to the source through the network. The client device is configured to receive the transmitted encoded video data through the network. The client device and/or the source is configured to time-stamp the video frames such that packets of a video frame have a common timestamp. The client device is further configured to decode the video frames at a level of a portion of a video frame instead of a level of the video frame based on the time-stamping.

The methods and systems disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

The embodiments of this invention are illustrated by way of example and not limitation in the figures of the accompanying drawings, in which like references indicate similar elements and in which:

FIG. 1 is a schematic view of a data streaming system, according to one or more embodiments.

FIG. 2 is a schematic view of a multimedia framework implemented in a client device of the data streaming system of FIG. 1.

FIG. 3 is an illustrative view of two video frames in the context of frame-level decoding thereof in a typical implementation.

FIG. 4 is an illustrative view of two video frames in the context of slice-level decoding thereof, according to one or more embodiments.

FIG. 5 is a flowchart detailing the operations involved in the decoding of a video frame of FIG. 4.

FIG. 6 is a process flow diagram detailing the operations involved in low latency sub-frame level video decoding through the data streaming system of FIG. 1, according to one or more embodiments.

Other features of the present embodiments will be apparent from the accompanying drawings and from the detailed description that follows.

### DETAILED DESCRIPTION

Example embodiments, as described below, may be used to provide a method, a device and/or a system of low latency sub-frame level video decoding. Although the present embodiments have been described with reference to specific example embodiments, it will be evident that various modifications and changes may be made to these embodiments without departing from the broader spirit and scope of the various embodiments.

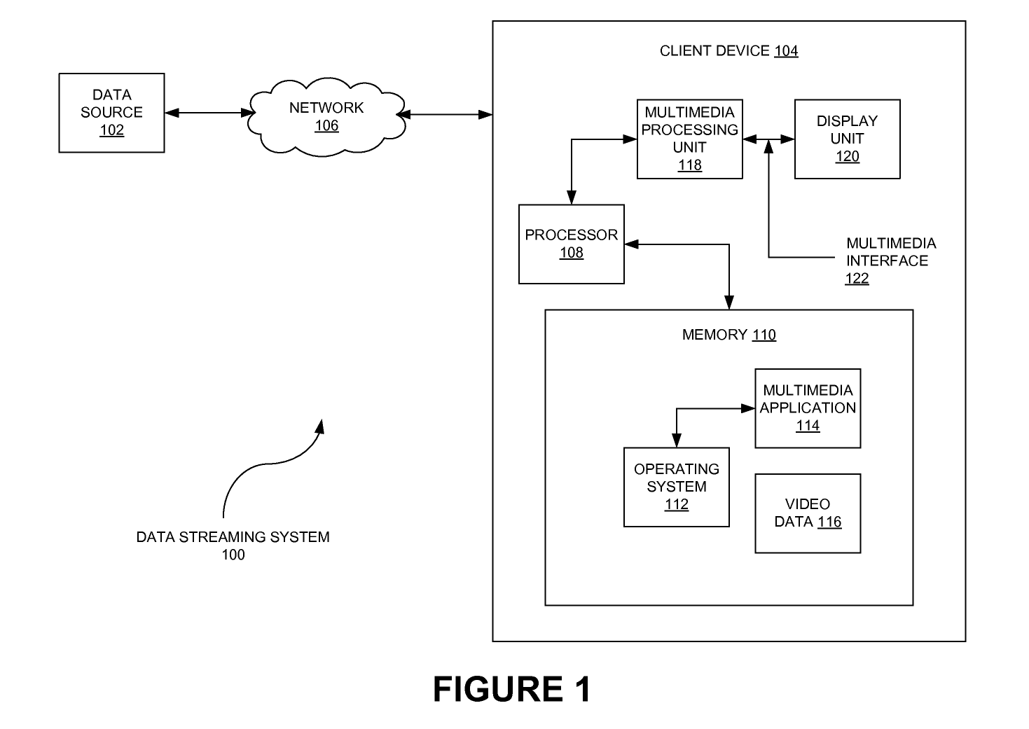

FIG. 1 shows a data streaming system 100, according to one or more embodiments. In one or more embodiments, data streaming system 100 may include a data source 102 communicatively coupled to one or more client devices (e.g., client device 104) through a network 106 (e.g., Internet, Local Area Network (LAN), Wide Area Network (WAN)). It is obvious that a single client device 104 is merely shown as an example in FIG. 1. In one or more embodiments, data source 102 may be a server configured to generate real-time data, encode the aforementioned real-time data as video data and transmit the video data to client device 104 through network 106. For example, data streaming system 100 may be a cloud-gaming environment where latency above a threshold severely degrades gaming experience on, say, client device 104.

It should be noted that data streaming system 100 is not limited to the cloud-gaming environment mentioned above. For example, data source 102 may also be a mere personal computer transmitting data wirelessly (e.g., through Wi-Fi®) to a tablet (an example client device 104) coupled to a television (for display purposes) through a High-Definition Multimedia Interface (HDMI) cable. All example data streaming systems having the capability to incorporate concepts discussed herein therein are within the scope of the exemplary embodiments.

In typical solutions, a video frame may be received at client device 104, following which a decoder thereat decodes the video frame. The aforementioned decoding may be started only after the complete video frame is received; in other words, the complete video frame may have to be received prior to even starting decoding of the first macroblock thereof. FIG. 1 shows client device 104 as including a processor 108 communicatively coupled to a memory 110. In one or more embodiments, processor 108 may be a Central Processing Unit (CPU), a Graphics Processing Unit (GPU) and/or any dedicated processor configured to execute an appropriate decoding engine thereon (decoding engine may instead be hardware); the dedicated processor may, alternately, be configured to control the appropriate decoding engine executing on another processor. All variations therein are within the scope of the exemplary embodiments. In one or more embodiments, memory 110 may be a volatile memory and/or a non-volatile memory.

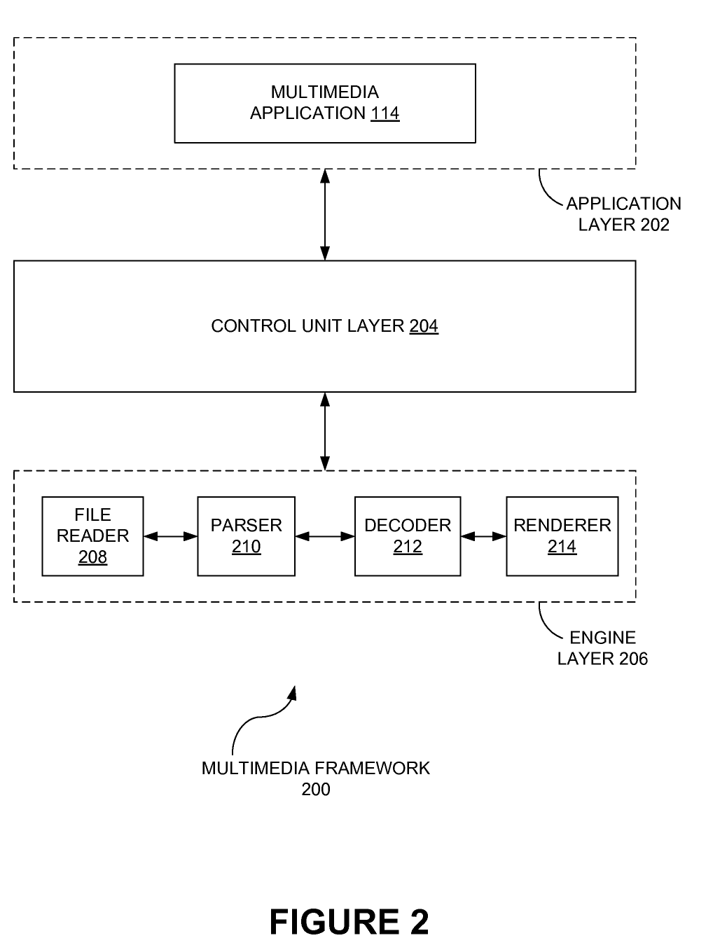

It is obvious that an operating system 112 may execute on client device 104. FIG. 1 shows operating system 112 as being stored in memory 110 (e.g., non-volatile memory). In one or more embodiments, client device 100 may execute a multimedia application 114 on processor 108; multimedia application 114 may be configured to render video data as a stream on an interface thereon. FIG. 1 shows multimedia application 114 as being stored in memory 110 to be executed on processor 108. FIG. 1 also shows video data 116 to be streamed through multimedia application 114 as also being resident in memory 110 (e.g., volatile memory). In one or more embodiments, multimedia application 114 may utilize an Application Programming Interface (API) of a multimedia framework (to be discussed with regard to FIG. 2) in order to execute processing associated therewith.

In one or more embodiments, output data associated with processing through processor 108 may be input to a multimedia processing unit 118 configured to perform encoding/decoding associated with the data. In one or more embodiments, the output of multimedia processing unit 118 may be rendered on a display unit 120 (e.g., Liquid Crystal Display (LCD) display, Cathode Ray Tube (CRT) monitor) through a multimedia interface 122 configured to convert data to an appropriate format required by display unit 120.

FIG. 2 shows a multimedia framework 200 implemented in client device 104, according to one or more embodiments. In one or more embodiments, multimedia framework 200 may provide multimedia capture, processing and/or playback facilities utilizing local or remote sources. In one or more embodiments, multimedia framework 200 may be above a foundation layer that facilities access of hardware such as a soundcard. In one or more embodiments, multimedia framework 200 may include an application layer 202 configured to communicate with a control unit layer 204 to enable performing a task required by multimedia application 114. Thus, multimedia application 114 may be at a level of application layer 202. In one or more embodiments, control unit layer 204 may control dataflow through engines (or, modules; shown as part of engine layer 206) of multimedia framework 200 such as file reader 208, parser 210, decoder 212 (e.g., hardware engine or software engine) and renderer 214.

File reader 208 may be configured to enable reading of video data 116. Parser 210 (e.g., Moving Picture Experts Group (MPEG) parser, Audio-Video Interleave (AVI) parser, H.264 parser) may parse video data 116 into constituent parts thereof. Decoder 212 may decode a compressed or an encoded version of video data 116 and renderer 214 may transmit the decoded data to a destination (e.g., a rendering device). The rendering process may also include processes such as displaying multimedia on display unit 120, playing an audio file on a soundcard, writing the data to a file etc. It is obvious that the aforementioned engines (or, modules) are merely shown for illustrative purposes and that variations therein are within the scope of the exemplary embodiments.

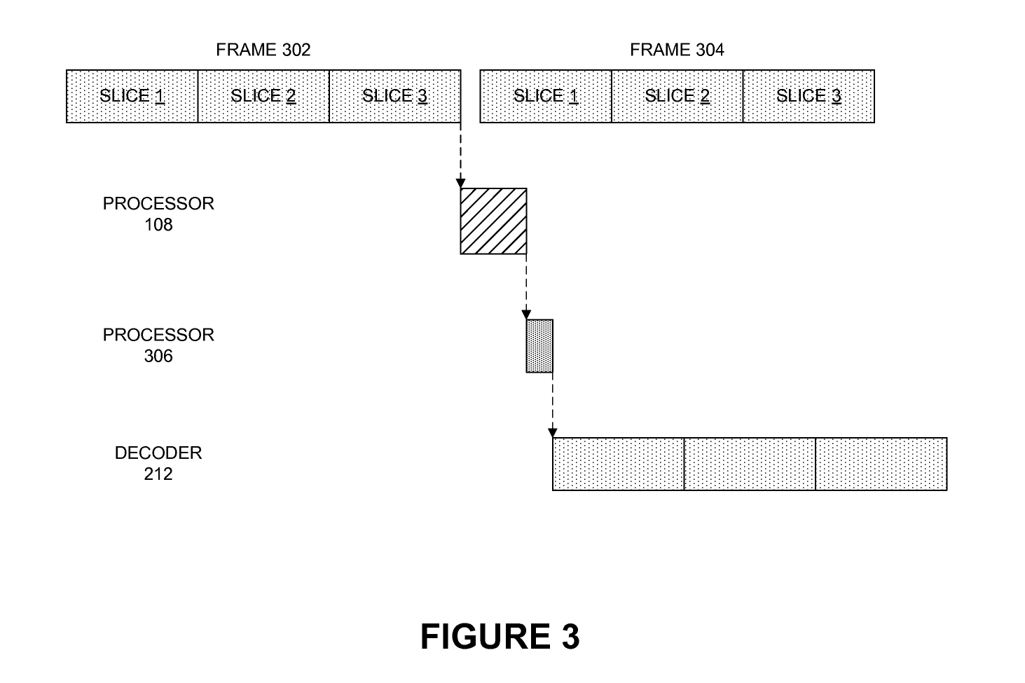

Further, it is obvious that multimedia framework 200 is merely shown for illustrative purposes, and that exemplary embodiments are not limited to implementations involving multimedia framework 200. FIG. 3 shows two frames, viz. frame 302 and frame 304 of video data 116 in the context of frame-level decoding thereof in a typical implementation. Assuming 1080 p, 60 frames per second (fps), 10 Mbps, H.264 encoded video data 116 served over network 106 having 20 Mbps average throughput with each frame (302, 304) having 10 constituent slices, the number of bits associated with each frame (302, 304) may be ˜167,000 (10,000,000/60). The network time taken for each frame (302, 304) may be 8.33 ms (167,000/20,000,000). Further, assuming that the decode time (e.g., hardware decoding) for one frame (302, 304) on an example processor 108 is 12 ms, the latency incurred during decoding of a frame (302, 304) is ˜20.33 ms.

FIG. 3 shows each of frame 302 and frame 304 as including three slices merely for the sake of illustration. Here, the time taken for processor 108 to decode the header for the first slice may be ˜0.3 ms. Moreover, processor 108 may prepare commands and transmit the aforementioned commands to a dedicated processor (e.g., processor 306 executing decoder 212 or triggering execution of decoder 212; the dedicated processor may also be processor 108), which then triggers decoder 212 for the purpose of decoding the complete frame 302. The time for the aforementioned preparation and transmission, along with the 0.3 ms time, is very small; therefore, it is to be noted that the aforementioned time may be neglected for the sake of simplicity. Further, it is to be noted that the encoded video data 116 (e.g., H.264 video data) may not include B-frames; therefore, the frames may be output from decoder 212 as soon as decoding thereof is done instead of waiting for a buffer (not shown; alternately, buffer may be memory 110) associated with decoder 212 to be full.

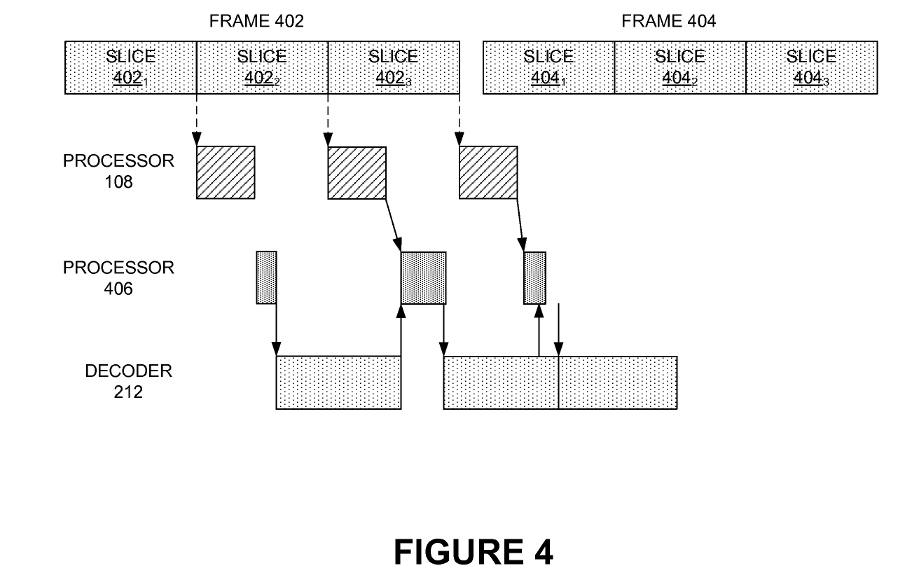

FIG. 4 shows two frames, viz. frame 402 and frame 404 in the context of slice-level decoding thereof, according to one or more embodiments; frame 402 and frame 404 have been shown to include three slices (e.g., slices 402₁₋₃ of frame 402 and slices 404₁₋₃ of frame 404) each for the sake of illustrative convenience. In accordance therewith, decoding of frame 402 and frame 404 may be started at the earliest by considering decoding at the slice level instead of the frame level discussed with regard to FIG. 3. In one or more embodiments, data source 102 may transmit encoded data (e.g., to be video data 116) in the form of packets such that each packet does not include data of more than one slice. In one or more embodiments, data source 102 may also be configured to time-stamp the packets such that packets of the same frame (e.g., frame 402) have the same timestamp; the next frame may have a different timestamp associated therewith. Alternately, in one or more embodiments, the aforementioned time-stamping may be performed at client device 104 through a depacketizer (e.g., implemented in decoder 212, implemented in other engines) thereat.

In one or more embodiments, decoder 212 may have a buffer (not shown; can be part of memory 110 or memory 110 itself) associated therewith; the aforementioned buffer may have data associated with one slice (say, slice 402₁) stored therein. As discussed above, the depacketizer may add timestamp information to the slice and transmit the data in the buffer to decoder 212, if the depacketizer is implemented separately from decoder 212. In one or more embodiments, decoder 212 may detect the presence of a new frame or the same frame being decoded based on the timestamp information. In one or more embodiments, if a new frame is detected, the header information of the first slice (e.g., slice 402₁) may be decoded. The buffer accessible through processor 108 may be selected and the data associated with the first slice copied into the buffer. In one or more embodiments, decoder 212 may then be triggered by processor 108 (if decoder 212 is implemented separately from processor 108; processor 108 may trigger another processor to, in turn, program decoder 212) to decode the aforementioned slice. Protocol implementations incorporating interrupts associated with requests, acknowledgments and errors are within the scope of the exemplary embodiments discussed herein.

In one or more embodiments, when an error is detected during decoding of the slice, an error concealment mechanism may be implemented (to be discussed below). In one or more embodiments, the process may proceed to the next slice (say, slice 402₂). In one or more embodiments, when a slice of the same frame being decoded is detected (e.g., through processor 108), the slice data may, again, be copied into the same buffer used for the previous slice (or, another buffer, depending on the implementation); the slice data for the new slice is copied after the slice data corresponding to the previous slice. In one or more embodiments, information related to the number of slices copied and the total size of data copied may be passed through a shared memory (e.g., memory 110) to the processor (e.g., processor 108) executing decoder 212 or capable of triggering decoder 212. In one or more embodiments, the aforementioned information may be available to the processor to enable the processor program the correct data size; the processor may also have information regarding the remaining number of slices to be decoded. In one or more embodiments, decoding of the slice may then be performed. Again, protocol implementations incorporating interrupts discussed above are within the scope of the exemplary embodiments.

In accordance with the example 1080 p, 60 frames per second (fps), 10 Mbps, H.264 encoded video data 116 served over network 106 having 20 Mbps average throughput with each frame (402, 404 here) having 10 constituent slices, the latency incurred during the slice-level decoding process for one frame may include the network time for the first slice (˜8.33/10=0.833 ms, assuming 10 slices per frame) and the hardware decode time (˜12 ms) for the frame; total latency is then ˜12.8 ms. In general, in one or more embodiments, as the network time and the hardware decode time may be parallelized, the maximum thereof limits the latency time.

It should be noted that the abovementioned latency data is associated with a specific implementation where a separate processor is utilized for programming hardware (e.g., decoder 212). It is obvious that a separate thread executing on processor 108 (e.g., CPU) may program the hardware directly.

FIG. 4 clearly shows the times incurred during the processes. With respect to processor 108, the first block corresponding to the end of slice 402₁ is associated with decoding header information of the first slice 402₁ of frame 402. Also, data associated with the second slice 402₂ may be copied after decoding the first slice 402₁. Therefore, second block corresponding to processor 108 may be associated with time related at least to the aforementioned copying. The copying may also result in a wait time with regard to processor 406 (analogous to processor 306); the wait time may also correspond to synchronization time related to informing decoder 212 of the number of remaining slices to be decoded and other related tasks. The aforementioned information related to the number of remaining slices may not be available after decoding of the first slice. 402₁. Therefore, processor 406 may be waiting for communication from decoder 212 that the first slice 402₁ is done, thereby contributing to the time consumption associated with the first block corresponding to processor 406. However, at the end of the decoding of the second slice 402₂, processor 406 merely may have to trigger decoder 212 to decode the third slice 402₃ after the third slice 402₃ is copied because information such as the number of slices to be decoded is available. Therefore, time consumed therein corresponding to processor 406 is very small.

As briefly mentioned above, exemplary embodiments may also incorporate error-concealment during the slice-level decoding. At any point in time, decoder 212 may not possess full data of a frame (e.g., frame 402). In one or more embodiments, when there is an error during decoding of a slice or a missing slice, the next slice of the frame is waited for. If the next slice is also not available, a command may be issued (e.g., through processor 108) to synchronize to the next slice. For example, this may be accomplished to determine the address of the first macroblock of the slice in which the error was detected; error-concealment (e.g., ignoring of missing packet data through processor 108) may be triggered from the macroblock in which the error was detected to the first macroblock of the next slice. Once error-concealment is done, normal decoding from the next slice onward may be triggered. If the missing packet data associated with a slice is received in a temporal future compared to the next decoded slice, the aforementioned received data may be ignored as reordering is not feasible during real-time communication. Additionally, lost/missing packet data may be predicted (e.g., through processor 108) based on the previous data.

It is obvious that errors may depend on the protocol implemented for communication through network 106; for example, Real-time Transport Protocol (RTP)/User Datagram Protocol (UDP)-based communication may be associated with lower latency when compared to Transmission Control Protocol (TCP)/Internet Protocol (IP)-based communication, where retransmission occurs to mitigate effect(s) of packet errors.

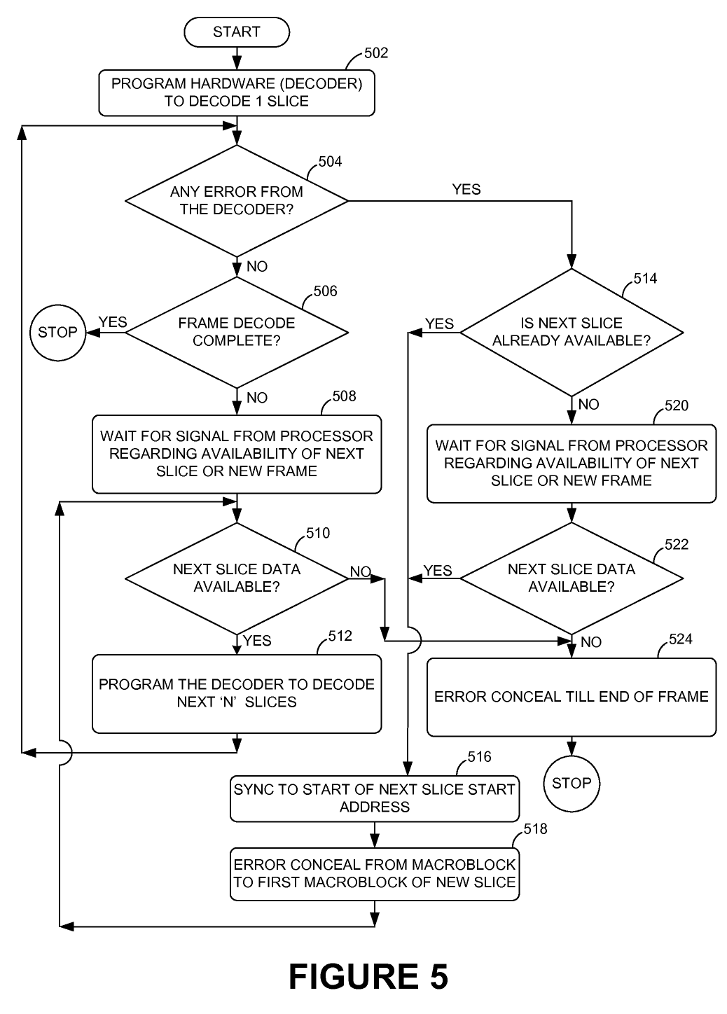

FIG. 5 shows a flowchart detailing the operations involved in the decoding of a frame (e.g., frame 402) discussed above. In one or more embodiments, operation 502 may involve programming the hardware (e.g., decoder 212) to decode a single slice (e.g., slice 402₁). In one or more embodiments, operation 504 may involve checking (e.g., through processor 108) as to whether any error from decoder 212 is detected. In one or more embodiments, if no, operation 506 may involve checking as to whether the decoding of the frame is complete. In one or more embodiments, if the result of operation 506 is yes, then the process may be terminated. In one or more embodiments, if the result of operation 506 is no, operation 508 may involve waiting for signal from processor 108 regarding availability of the next slice (e.g., slice 402₂) or the next frame (e.g., frame 404).

In one or more embodiments, operation 510 may then involve checking as to whether the next slice is available. In one or more embodiments, if yes, operation 512 may involve programming the hardware (e.g., decoder 212) to decode the next N slices (or, remaining slices of, say, frame 402). In one or more embodiments, the decoding of the next slice may proceed in the same manner discussed herein. In one or more embodiments, if the result of operation 504 is a yes (implying that there is an error from the hardware (e.g., decoder 212)), operation 514 may involve checking whether the next slice is already available. In one or more embodiments, if yes, operation 516 may involve synchronizing to the start of the start address of the next slice. In one or more embodiments, operation 518 may then involve error concealment from the macroblock in which error was detected to the first macroblock of the new slice (or, next slice). In one or more embodiments, control may then pass on to operation 510.

In one or more embodiments, if the result of operation 514 is a no, operation 520 may involve waiting for a signal from processor 108 regarding availability of the next slice (e.g., slice 402₂) or the next frame (e.g., frame 404). In one or more embodiments, operation 522 may involve checking as to whether data associated with the next slice is available. In one or more embodiments, if yes, control may be passed on to operation 516. In one or more embodiments, if no, operation 524 may involve error-concealment till the end of the frame (the new frame is detected and no new data for the current frame is available). In one or more embodiments, if the result of operation 510 is a no, then control may pass on to operation 524.

It should be noted that while exemplary embodiments have been discussed with regard to slice-level decoding, the granularity of the decoding may instead be at a macroblock level (not preferred as synchronization may be a problem). To generalize, granularity of the decoding may be at a level of a portion of a video frame having a number of such constituent portions. Thus, exemplary embodiments provide for reduced latency in critical cloud-computing environments. Further, it should be noted that while FIG. 4 shows frame 402 and frame 404 as being constituted by equal slices, frames including unequal slices (or, portions) are also within the scope of the exemplary embodiments discussed herein.

It is obvious that the engines of multimedia framework 200 and the processes/operations discussed above may be executed in conjunction with processor 108. Instructions associated therewith may be stored in memory 110 to be installed on client device 104 after a download through the Internet. Alternately, an external memory may be utilized therefor. Also, the aforementioned instructions may be embodied on a non-transitory medium readable through client device 104 such as a Compact Disc (CD), a Digital Video Disc (DVD), a Blu-ray™ disc, a floppy disk, or a diskette etc. The aforementioned instructions may be executable through client device 104.

The aforementioned instructions are not limited to specific embodiments discussed above, and may, for example, be implemented in operating system 112, an application program (e.g., multimedia application 114), a foreground or a background process, a network stack or any combination thereof. Other variations are within the scope of the exemplary embodiments discussed herein.

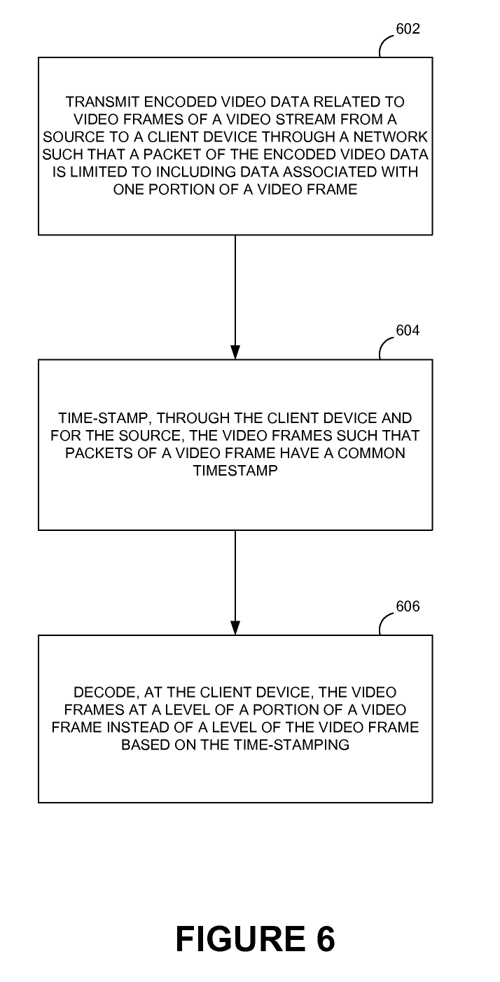

FIG. 6 shows a process flow diagram detailing the operations involved in low latency sub-frame level video decoding through data streaming system 100, according to one or more embodiments. In one or more embodiments, operation 602 may involve transmitting encoded video data 116 related to video frames (e.g., frame 402 and frame 404) of a video stream from a source (e.g., data source 102) to client device 104 through network 106 such that a packet of the encoded video data 116 is limited to including data associated with one portion (e.g., slice 402₁) of a video frame. In one or more embodiments, the video frame may include a number of portions (e.g., slices 402₁₋₃) including the one portion. In one or more embodiments, operation 604 may involve time-stamping, through client device 104 and/or the source, the video frames such that packets of a video frame have a common timestamp. In one or more embodiments, operation 606 may then involve decoding, at client device 104, the video frames at a level of a portion of a video frame instead of a level of the video frame based on the time-stamping.

Although the present embodiments have been described with reference to specific example embodiments, it will be evident that various modifications and changes may be made to these embodiments without departing from the broader spirit and scope of the various embodiments. For example, the various devices and modules described herein may be enabled and operated using hardware circuitry, firmware, software or any combination of hardware, firmware, and software (e.g., embodied in a non-transitory machine-readable medium). For example, the various electrical structure and methods may be embodied using transistors, logic gates, and electrical circuits (e.g., Application Specific Integrated Circuitry (ASIC) and/or Digital Signal Processor (DSP) circuitry).

In addition, it will be appreciated that the various operations, processes, and methods disclosed herein may be embodied in a non-transitory machine-readable medium and/or a machine accessible medium compatible with a data processing system (e.g., client device 104), and may be performed in any order (e.g., including using means for achieving the various operations).

Accordingly, the specification and drawings are to be regarded in an illustrative rather than a restrictive sense.

What is claimed is:

1. A method comprising:
transmitting encoded video data related to video frames of a video stream from a source to a client device through a network such that a packet of the encoded video data is limited to including data associated with one portion of a video frame, the video frame comprising a plurality of portions including the one portion;
time-stamping, through at least one of the client device and the source, the video frames such that packets of a video frame have a common timestamp; and
decoding, at the client device, the video frames at a level of a portion of a video frame instead of a level of the video frame based on the time-stamping.

2. The method of claim 1, wherein the decoding of the video frames at the client device at the level of the portion of the video frame further comprises:
accumulating, at the client device, the data associated with the one portion of the video frame in a buffer;
detecting, through a processor of the client device, whether the buffer includes one of a subsequent portion of the video frame being decoded and a new video frame;
in response to the new video frame being detected,
decoding a header of a first portion of the new video frame;
copying data related to the first portion of the new video frame into a free buffer; and
decoding the first portion of the new video frame; and
in response to the subsequent portion of the video frame being detected,
copying data related to the subsequent portion of the video frame into one of the buffer utilized for a previous portion of the video frame after the already copied data and another buffer; and
programming, through the processor, a decoder of the client device based on information of a number of portions of the video frame copied and a total size of the data copied for the video frame to enable the decoder decode the subsequent portion of the video frame and a remaining number of portions of the video frame.

3. The method of claim 1, wherein the plurality of portions of the video frame is a plurality of slices of the video frame.

4. The method of claim 2, wherein at least one of:
the decoder of the client device is one of a hardware engine on the client device and an engine executing on the processor, and
the processor is configured to control another processor on the client device to trigger the decoder.

5. The method of claim 1, further comprising implementing an interrupt mechanism through the processor to signify an end of decoding of at least one of a portion of the video frame and the video frame.

6. The method of claim 2, further comprising:
detecting, through the processor, an error in the decoding of a portion of the video frame; and
error-concealing, through the processor, from a macroblock of the portion of the video frame in which the error is detected to a first macroblock of a subsequent portion of the video frame.

7. The method of claim 6, further comprising at least one of:
error-concealing, through the processor, till an end of the video frame when no new data for the video frame is available and a new video frame is detected;
ignoring, through the processor, a packet associated with the portion of the video frame being decoded arriving at a temporal future relative to the video frame being decoded; and
predicting, through the processor, lost data related to the portion of the video frame being decoded based on data related to a previous portion of the video frame decoded.

8. A non-transitory medium, readable through a data processing device and including instructions embodied therein that are executable through the data processing device, comprising:
instructions to receive encoded video data related to video frames of a video stream transmitted from a source at the data processing device through a network such that a packet of the encoded video data is limited to including data associated with one portion of a video frame, the video frame comprising a plurality of portions including the one portion;
instructions to time stamp, through the data processing device, the video frames such that packets of a video frame have a common timestamp; and
instructions to decode, at the data processing device, the video frames at a level of a portion of a video frame instead of a level of the video frame based on the time-stamping.

9. The non-transitory medium of claim 8, wherein instructions to decode the video frames at the level of the portion of the video frame further comprise:
instructions to accumulate, at the data processing device, the data associated with the one portion of the video frame in a buffer;
instructions to detect, through a processor of the data processing device, whether the buffer includes one of a subsequent portion of the video frame being decoded and a new video frame;
in response to the new video frame being detected,
instructions to decode a header of a first portion of the new video frame;
instructions to copy data related to the first portion of the new video frame into a free buffer; and
instructions to decode the first portion of the new video frame; and
in response to the subsequent portion of the video frame being detected,
instructions to copy data related to the subsequent portion of the video frame into one of the buffer utilized for a previous portion of the video frame after the already copied data and another buffer; and
instructions to program, through the processor, a decoder of the data processing device based on information of a number of portions of the video frame copied and a total size of the data copied for the video frame to enable the decoder decode the subsequent portion of the video frame and a remaining number of portions of the video frame.

10. The non-transitory medium of claim 8, comprising instructions compatible with the plurality of portions of the video frame being a plurality of slices of the video frame.

11. The non-transitory medium of claim 8, further comprising instructions to implement an interrupt mechanism through the processor to signify an end of decoding of at least one of a portion of the video frame and the video frame.

12. The non-transitory medium of claim 9, further comprising:
instructions to detect, through the processor, an error in the decoding of the portion of the video frame; and
instructions to error-conceal, through the processor, from a macroblock of the portion of the video frame in which the error is detected to a first macroblock of a subsequent portion of the video frame.

13. The non-transitory of claim 12, further comprising at least one of:
instructions to error-conceal, through the processor, till an end of the video frame when no new data for the video frame is available and a new video frame is detected;
instructions to ignore, through the processor, a packet associated with the portion of the video frame being decoded arriving at a temporal future relative to the video frame being decoded; and
instructions to predict, through the processor, lost data related to the portion of the video frame being decoded based on data related to a previous portion of the video frame decoded.

14. A system comprising:
a source to transmit encoded video data related to video frames of a video stream such that a packet of the encoded video data is limited to including data associated with one portion of a video frame, the video frame comprising a plurality of portions including the one portion;
a network; and
a client device communicatively coupled to the source through the network, the client device being configured to receive the transmitted encoded video data through the network, at least one of the client device and the source being configured to time-stamp the video frames such that packets of a video frame have a common timestamp, and the client device further being configured to decode the video frames at a level of a portion of a video frame instead of a level of the video frame based on the time-stamping.

15. The system of claim 14, wherein the client device is configured to decode the video frames at the level of the portion of the video frame based on:
accumulating the data associated with the one portion of the video frame in a buffer,
detecting, through a processor of the client device, whether the buffer includes one of a subsequent portion of the video frame being decoded and a new video frame,
in response to the new video frame being detected,
decoding a header of a first portion of the new video frame,
copying data related to the first portion of the new video frame into a free buffer, and
decoding the first portion of the new video frame, and
in response to the subsequent portion of the video frame being detected,
copying data related to the subsequent portion of the video frame into one of the buffer utilized for a previous portion of the video frame after the already copied data and another buffer, and
programming, through the processor, a decoder of the client device based on information of a number of portions of the video frame copied and a total size of the data copied for the video frame to enable the decoder decode the subsequent portion of the video frame and a remaining number of portions of the video frame.

16. The system of claim 14, wherein the plurality of portions of the video frame is a plurality of slices of the video frame.

17. The system of claim 15, wherein at least one of:
the decoder of the client device is one of a hardware engine on the client device and an engine executing on the processor, and
the processor is configured to control another processor on the client device to trigger the decoder.

18. The system of claim 14, wherein the client device includes an interrupt mechanism implemented therein through the processor to signify an end of decoding of at least one of a portion of the video frame and the video frame.

19. The system of claim 15, wherein the processor of the client device is further configured to:
detect an error in the decoding of the portion of the video frame, and
error-conceal from a macroblock of the portion of the video frame in which the error is detected to a first macroblock of a subsequent portion of the video frame.

20. The system of claim 19, wherein the processor of the client device is further configured to at least one of:
error-conceal till an end of the video frame when no new data for the video frame is available and a new video frame is detected,
ignore a packet associated with the portion of the video frame being decoded arriving at a temporal future relative to the video frame being decoded, and
predict lost data related to the portion of the video frame being decoded based on data related to a previous portion of the video frame decoded.
